(19) United States
(12) Patent Application Publication
(10) Pub. No.: US 2001/0049796 A1
(43) Pub. Date: Dec. 6, 2001

(54) Authentication-technology independent, non-programmatic method and apparatus for bootstrapping a user database from the WEB tier

(76) Inventors: Mark L. Roth, Lowell, MA (US); Ronald M. Monzillo, Lexington, MA (US); Kevin Grant Osborn, Newton Highlands, MA (US); William A. Shannon, Los Altos, CA (US)

Correspondence Address: BEYER WEAVER & THOMAS LLP, P.O. BOX 778, BERKELEY, CA, 94704-0778, US

(21) Appl. No.: 09/873,095

(22) Filed: May 31, 2001

Related U.S. Application Data
(60) Provisional application No. 60/208,997, filed on Jun. 1, 2000.

(51) Int. Cl. G06F 12/00

(52) U.S. Cl. 713/201

(57) ABSTRACT

A non-programmatic method for bootstrapping a user database from the web tier using pass-through server-provided form targets is disclosed. A “form target,” used in this context, is the submission destination of an HTML form, submitted via HTTP (typically this is called an “action” in HTTP). The “form target” is usually the name of a CGI script, or an alias to an ASP, Servlet or JSP on the server, which will handle a form request. When the user submits a form via HTTP, the application server will extract security data and then pass control back to an application success target or a failure target.

### CROSS REFERENCE TO RELATED APPLICATION

This application takes priority under 35. U.S.C. 119(e) from U.S. Provisional Patent Application No.: 60/208,997 entitled “AN AUTHENTICATION-TECHNOLOGY INDEPENDENT, NON-PROGRAMMATIC METHOD AND APPARATUS FOR BOOTSTRAPPING A USER DATABASE FROM THE WEB TIER” by Roth et. al. filed Jun. 1, 2000 which is incorporated by reference in its entirety for all purposes.

### BACKGROUND OF THE INVENTION

1. Field of Invention

The invention relates generally to computer systems. More particularly, methods and apparatus for providing an authentication-technology independent, non-programmatic method and apparatus for bootstrapping a user database from the WEB tier.

2. Description of Relevant Art

Most web application servers provide applications with programmatic access to one or more authentication mechanisms. Applications, which run on these servers, use the APIs provided by the application server to authenticate their users. For example, servers implementing NSAPI define a set of “AuthTrans-class functions,” including “basic-auth” which “calls a custom function to verify user name and password”. Servers implementing Microsoft's ISAPI provide an API call called “GetServerVariable” that allows access to the authentication type (such as “Kerberos, user,SSL/PCT, Basic, [or] integrated Windows authentication”) and authentication information, such as certificate information or username and password. Other servers handle this in a similar fashion.

Many application servers also provide a programmatic account creation interface such that first-time users may use an application to create accounts for themselves. This ability to auto-register with an application is important to the viability of web applications as it provides an automated path past the barrier represented by lack of an account without requiring the assistance of administrative personnel within the enterprise. An application, which uses the account creation interfaces, is easily able to customize many aspects of the user registration process including look and feel and the collection of any ancillary (profile) data associated with the user.

Java2™ Platform, Enterprise Edition (J2EE) application servers take a new approach to the implementation of security related functionality, in that security functionality such as that related to user authentication or account creation is done on behalf of the application by an enhanced application server referred to as a container. The security functionality performed by the container on behalf of the application is defined external to the application implementation. This approach frees application component providers from implementing complex security functionality and ensures that application components do not become encumbered by calls that would limit their ability to be deployed in diverse operational environments.

Therefore, what is desired is a non-API based mechanism for bootstrapping a user database that is consistent with the goals of the J2EE platform and which has many of the same advantages as an API approach.

### SUMMARY OF THE INVENTION

A non-API based mechanism for bootstrapping a user database that is consistent with the goals of the J2EE platform and which has many of the same advantages as an API approach is disclosed.

In one embodiment, a method for bootstrapping a user database associated with an application from an application server in a browser/server environment is disclosed. A user information request page is formed by the application, which is then sent to a user. The user returns a filled out user information request page to the application server which then extracts security data from the filled out user information page. The application server then bootstraps a user account in the user database based upon the extracted security data.

In another embodiment, an apparatus for bootstrapping a user database associated with an application from an application server in a browser/server environment is disclosed.

In yet another embodiment, a computer program product for bootstrapping a user database associated with an application from an application server in a browser/server environment is disclosed.

These and other advantages of the present invention will become apparent upon reading the following detailed descriptions and studying the various figures of the drawings.

### BRIEF DESCRIPTION OF THE DRAWINGS

The invention, together with further advantages thereof, may best be understood by reference to the following description taken in conjunction with the accompanying drawings in which:

FIG. 1 shows an unregistered user requesting a registration page in a browser/server system in accordance with an embodiment of the invention.

FIG. 2 shows the browser/server system of FIG. 1 whereby the user responds to a received registration page.

FIGS. 3-5 illustrate flowcharts detailing a process for bootstrapping a user database from the Web tier in accordance with an embodiment of the invention.

FIG. 6 is a diagrammatic representation of a general-purpose computer system suitable for implementing the present invention.

FIG. 7 is a diagrammatic representation of a virtual machine suitable for implementing the present invention.

### DETAILED DESCRIPTION OF THE EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

In accordance with one embodiment of the present invention, there is provided a non-API based mechanism for bootstrapping a user database that is consistent with the goals of the J2EE platform and which has many of the same advantages as an API approach. Broadly speaking, without the requirement of an API, the invention enables an unauthenticated user to create a new account via a web interface (by providing a username, password, and password verification, for example). This is desirable so that a system administrator need not be present to create user accounts for applications in which it is reasonable to allow users to create their own accounts. The invention also provides for a deployer of a web application (instead of the application developer) to configure the security environment. This is desirable because it takes the burden of implementing security correctly out of the application developer's hands. Thereby promoting reusability of security-related code in the application server, and increasing the chance that security is implemented correctly. It also allows a single application to operate in more environments.

The invention further provides for flexibility to support multiple and/or new authentication technologies without change to the existing web application code. This is desirable because it enables the deployer more flexibility in choosing an authentication technology appropriate to the deployment environment, and it allows web applications to vary independently of available authentication technologies. A NSAPI or ISAPI application, for example, would need to be altered to support a new authentication technology in this absence of this solution.

In addition, the invention enables appearance customization of these web applications by the application developer. Web applications vary greatly in appearance and look and feel. In many cases, it would not be acceptable to sacrifice user appearance customization in exchange for the benefits previously described. Furthermore, the invention enables error handling for account creation and maintenance by the application developer. This is desirable because the web application may need to perform special processing in the event of an account creation error. When applicable, the invention enables a user to change passwords via a web interface (by providing a username, old password, new password and password verification, for example). This is desirable so that a system administrator need not be present to change user passwords for applications in which it is reasonable to allow users to change their own passwords.

In order to satisfy these requirements, this invention uses the concept of “pass-through server-provided form targets” as a non-programmatic method for bootstrapping a user database from the web tier. A “form target,” used in this context, is the submission destination of an HTML form, submitted via HTTP (typically this is called an “action” in HTTP). The “form target” is usually the name of a CGI script, or an alias to an ASP, Servlet or JSP on the server, which will handle a form request. When the user submits a form via HTTP, the web browser will redirect the user to the given form target. A “server-provided form target” is a form target that is provided by the server instead of by the web application. This form target is accessible to any application deployed on the server, and therefore can be reused. Typically, when a user submits a form to a “server-provided form target,” the application server has some way of knowing the page to redirect the user to after processing the form submission.

In order to facilitate understanding of the following detailed description, a brief summary of the terminology used herein is presented. Accordingly, the following terminology is used in this description:

1) an application developer is that party responsible for creating a web application;

2) an application server is a host for applications, providing various services such as security services;

3) a deployer is the user or users responsible for installing a web application on an application server and configuring the web application for the target environment; and

4) a web application is a multi-tiered program that is being run in the context of an application server that utilizes a web front-end.

Although the invention will initially be described in terms of a multithreaded, object oriented computing system implemented using HTTP requests and responses, it should be noted that the present invention can be used in any system that is capable of handling well defined requests and responses across a distributed network.

It should be noted that although the invention is also described in terms of the Internet, any distributed network could be suitably employed to implement any desired embodiment of the invention. It is one of the advantages of the invention that it is well suited for low bandwidth systems capable of executing client side applications. Such low bandwidth systems include, but are not limited to: virtual private networks direct serial connections across telephone lines (“BBS systems”), and LANs and WANs regardless of network protocol.

When implemented in a network using the HTTP protocol, such as the Internet, when an end user (i.e., client) desires to run an application within a browser environment, the end user generates an HTTP request for a resource identified by a URL (universal resource locator). In one implementation, this request is transmitted by way of a distributed network, such as the Internet, to a server computer.

The invention will now be described in terms of a browser resident in a client computer that is typically used to execute an e-commerce application. It should be noted, however, that any applications requiring data processing in a highly interactive environment can also be implemented using the invention, and the invention therefore should not be construed as being limited to e-commerce applications. It should also be noted, that the invention is well suited for any low bandwidth system in which user interactivity is a prime consideration.

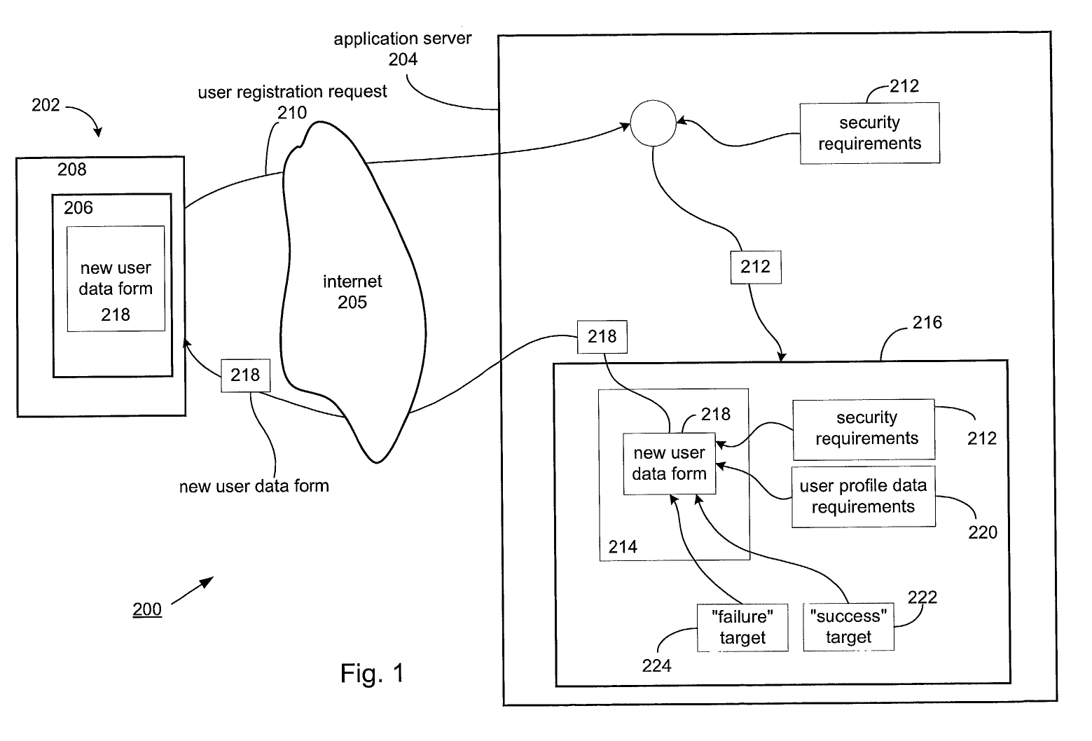

Referring now to FIG. 1, a browser/web application server system 200 in accordance with an embodiment of the invention is shown. It should be noted that in terms of the described embodiment, a Web application server is an arrangement whereby an application server combines or works with a Web server such that the Web browser supports an easy-to-create HTML-based front-end for the user. The Web server provides several different ways to forward a request to an application server and to forward back a modified or new Web page to the user. These approaches include the Common Gateway Interface (CGI), Active Server Page (ASP) and the Java Server Page (JSP).

Accordingly, the system 200 includes a client computer 202 coupled to an application server 204. Typically, the application server 204 is part of a distributed interconnected computer network 205 such as the Internet, but can also be part of a private wide or local area network (WAN/LAN) utilizing HTTP protocols, sometimes referred to as an intranet. It is one of the advantages of the invention that the interconnected computer network can be any low bandwidth system. In order to facilitate communication between the various users and/or computers that form the network 205, the client computer 202 utilizes the graphical user interface resources presented by a Web page (sometimes referred to as an HTML page) 206 resident in a browser 208, most of which are obtained by various HTTP requests. When a user desires to download a particular HTML page 206 from the application server 204, the browser 208 generates an HTTP request having a URL for the requested page 206 that includes information related both to the location of the Web application server 204, and to the location within the application server 204 where the page 206 is located.

In order, therefore, to register as a new user using the web browser 208, an unregistered, unauthenticated user generates a user registration page request 210 and forwards it to the application server 204. In the described embodiment, the application server 204 embeds a set of security registration data requirements 212 (e.g. usernme, password, realm, etc.) in the request 210 and forwards the request 210 to a user registration page 214 in a web application 216. In some cases, the security data requirements include, for example, a username, a choice of realm (i.e., East Coast, West Coast, Central, etc.), a user password and a password confirmation. It should be noted that in a particular Java™ based implementation the security registration data requirements can be passed, for example, as an attribute in a ServietRequest object if the application uses the Java Servlet API.

In the described embodiment, the user registration page 214 then puts together a new user data form 218, merging the security registration data requirements 212 along with various user profile registration data requirements 220 (e.g. phone number, city, state, zip) from the application 216. It should be noted that the form 218 is consistent with the look and feel of the web application 216 such as for example, an HTML type form, an XML type form, etc. In some embodiments, the application server 204 provides a way of turning the requirements 212 into a set of HTML tags, for example, to be used in the form 218, such as providing a page to be included within an HTML form. This would reduce the complexity of applications that don't care as much about the look and feel of the security portions of the user registration form.

In the described embodiment, the web application 216 also includes a success file (or “success target”) 222 that informs the application server 204 the page to redirect the user in the event of successful account creation. In addition, the web application 216 includes a failure file (or “failure target”) 224 that informs the application server 204 the page to redirect the user in the event of failed, or unsuccessful, account creation. In particular, the targets 222 and 224 typically take the form of URLs, the exact name of which can be specified by the application server 204. Once the form 218 is configured, the web application 216 sends the form 218 to the user.

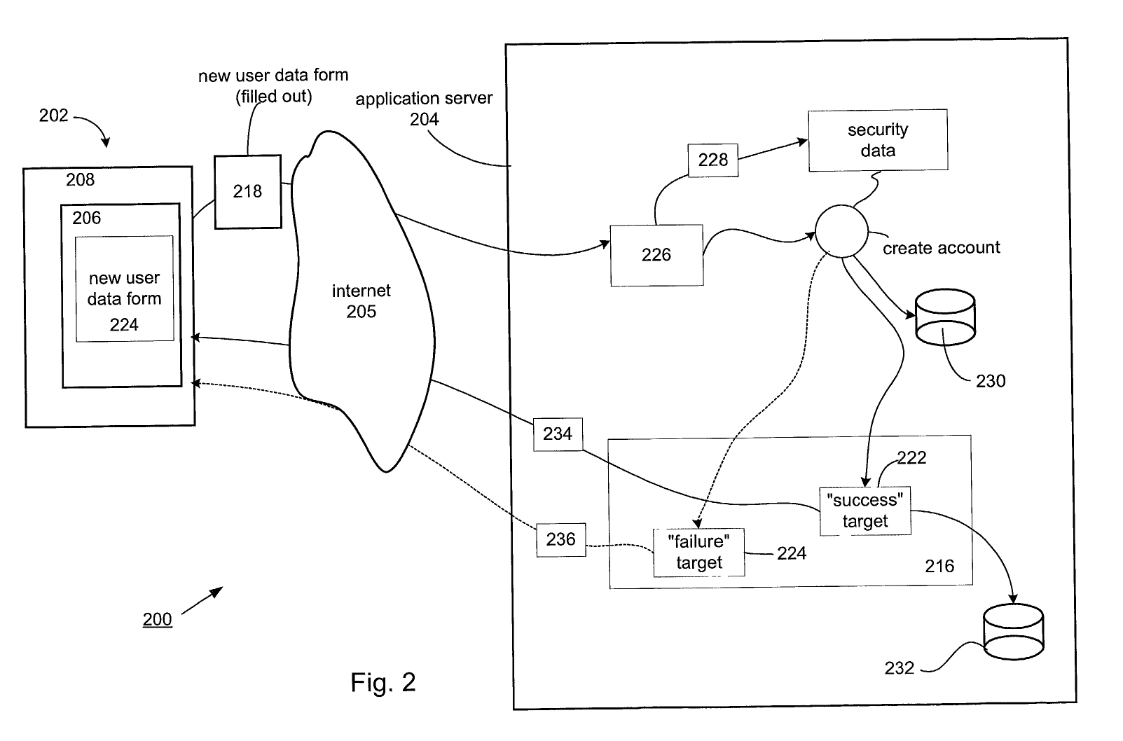

Referring to FIG. 2, once the user fills out the form 218 with the appropriate information, the user submits the form 218 back to a pass-through server-provided form target 226 in the application server 204. The application server 204 then retrieves requested security data 228 it requires to create a new account and attempts account creation in a user data base 230. Upon successful account creation, the success target 222 is invoked. However, if an error occurs during account creation, the failure target 224 is invoked. It should be noted that all form submission data is forwarded to whichever of these targets is invoked. When the success target 222 is invoked, the application 216 will typically verify and store user profile data in a user profile database 232 and send back a success page 234 suitable for a registered user. However, when the failure target 224 is invoked, the application 216 will typically send back a failure page 236 suitable for an unregistered user.

In a Java™ based system, if an error occurs during account creation, the failure page 236 returned to the user can be the output of the JSP, Servlet, etc. specified in the failure target 224. This would normally be a web-application provided page. The application server 204 passes in all the user profile information as if the user submitted the form directly to the error target. At this point, the web application 216 would likely indicate what went wrong, and allow the user to fix it, possibly pre-filling any form fields with the information the user provided on the previous form submission and indicating which fields may have problems.

In a Java™ based system, if the account creation was a success, the success page 234 returned to the user can be the output of the JSP, Servlet, etc. specified in the success target 222. This would also normally be a web-application provided page. The server 204 passes in all the user profile information and security information as if the user submitted the form directly to the success target 222. At this point, the web application 216 would likely check the user profile information to ensure it is valid. If it were not valid, the application 216 would not need to re-prompt for security information since the server 204 already created the user's account.

It should be noted that all future form submissions would not need to be made to the pass-through server-provided form target 226 and could, instead, be submitted directly to a web-application-provided page. If user profile information is valid, the web application 216 can enable the user's account. It should be noted that a set of initial privilege attributes should be associated with newly created users.

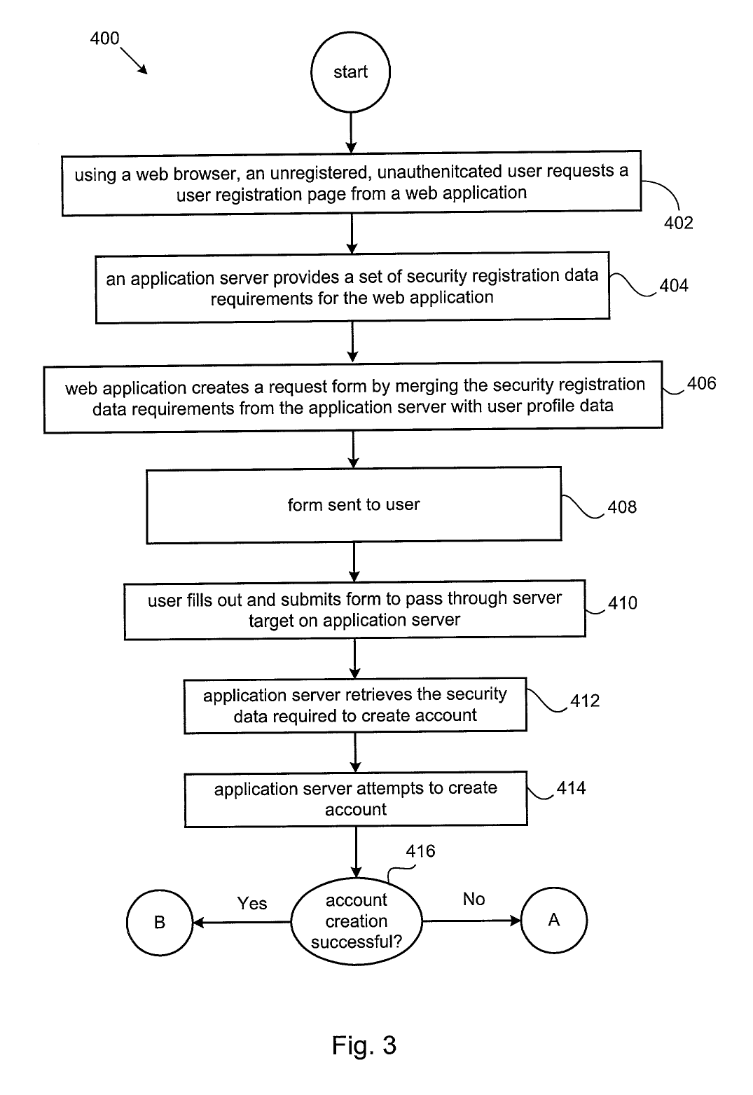

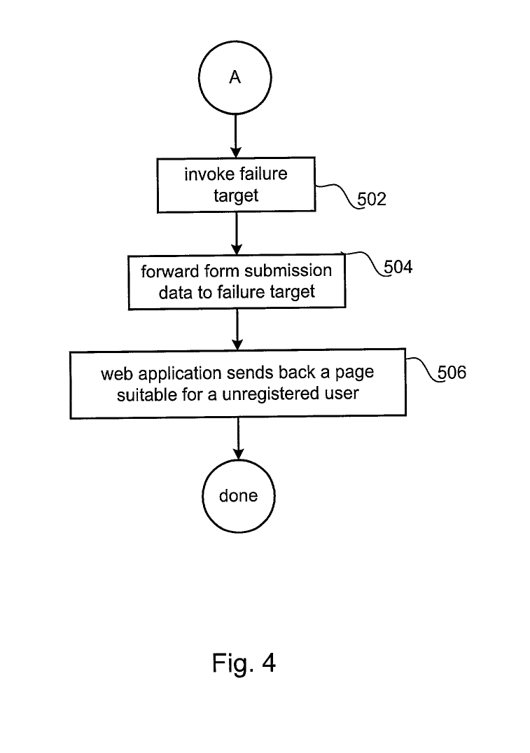

FIGS. 3-5 illustrate flowcharts detailing a process 400 for bootstrapping a user database from the Web tier in accordance with an embodiment of the invention. The process 400 begins at 402 by an unregistered and unauthenticated user requesting a user registration page from a web application using a browser. At 404, an application server provides a set of security registration data requirements to the web application consistent with the user request. Next, at 406, the web application creates a request form by merging the security registration requirements from the application server with a user profile database. The web application then forwards the form to the user at 408 who fills out the form and sends the filled out form back to a pass-through server target on application server at 410. The application server then retrieves from the user response any security data required to create an account at 412, which is attempted at 414. Based upon the retrieved data, a determination is made at 416 whether or not a new account has been successfully created. If a new account has not been successfully created, then in FIG. 4, a failure target is invoked at 502 and form submission data is forwarded to the failure target at 504. At 506, the web application sends back a page to the user suitable for an unregistered user.

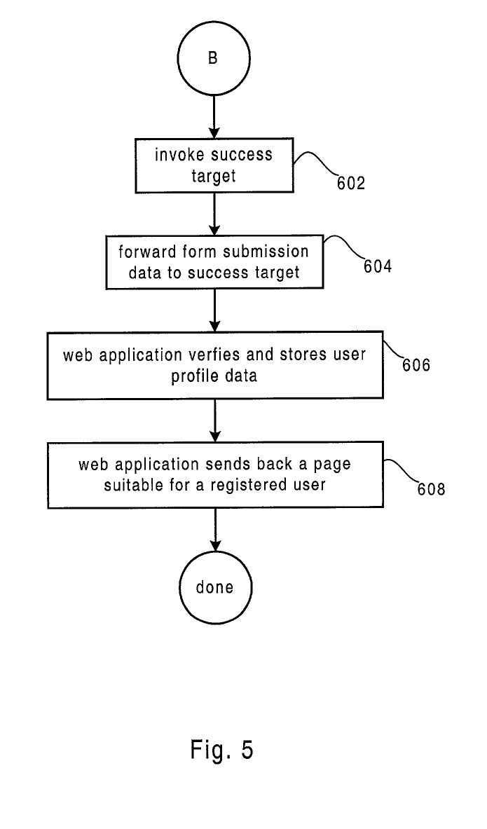

If, however, at 416, it has been determined that a new account was created, then in FIG. 5, a success target 602 is invoked and form submission data is forwarded to the success target at 604. The web application then verifies and stores user profile data at 606 and at 608, the web application sends back a page to the user suitable for a registered user.

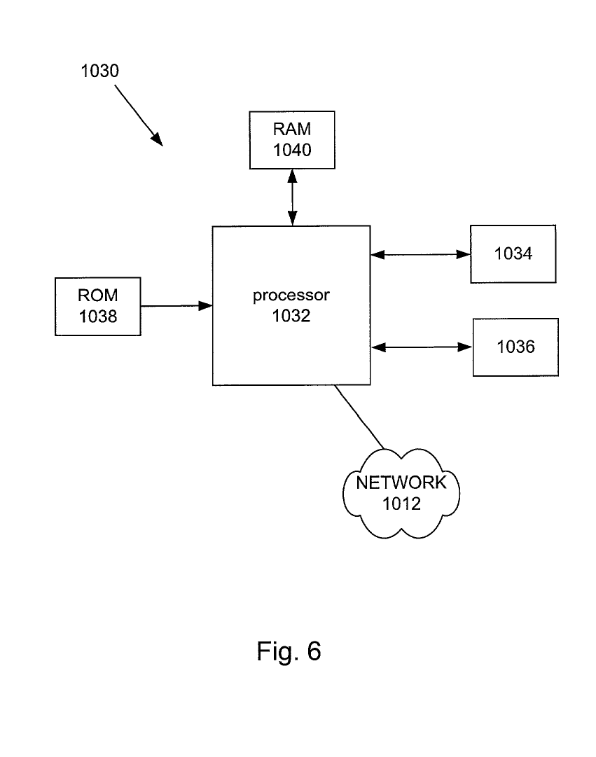

FIG. 6 illustrates a typical, general-purpose computer system suitable for implementing the present invention. The computer system 1030 includes at least one processor 1032 (also referred to as a central processing unit, or CPU) that is coupled to memory devices including primary storage devices 1036 (typically a read only memory, or ROM) and primary storage devices 1034 (typically a random access memory, or RAM).

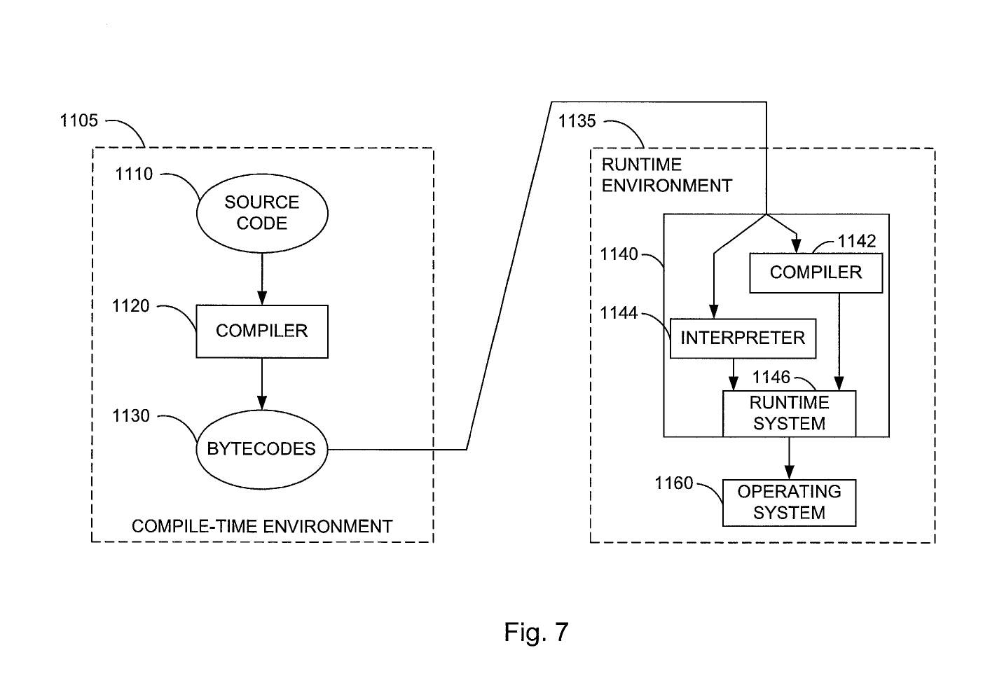

Computer system 1030 or, more specifically, CPUs 1032, may be arranged to support a virtual machine, as will be appreciated by those skilled in the art. One example of a virtual machine that may be supported on computer system 1030 will be described below with reference to FIG. 7. As is well known in the art, ROM acts to transfer data and instructions uni-directionally to the CPUs 1032, while RAM is used typically to transfer data and instructions in a bi-directional manner. CPUs 1032 may generally include any number of processors. Both primary storage devices 1034, 1036 may include any suitable computer-readable media. A secondary storage medium 1038, which is typically a mass memory device, is also coupled bi-directionally to CPUs 1032 and provides additional data storage capacity. The mass memory device 1038 is a computer-readable medium that may be used to store programs including computer code, data, and the like. Typically, mass memory device 1038 is a storage medium such as a hard disk or a tape which generally slower than primary storage devices 1034, 1036. Mass memory storage device 1038 may take the form of a magnetic or paper tape reader or some other well-known device. It will be appreciated that the information retained within the mass memory device 1038, may, in appropriate cases, be incorporated in standard fashion as part of RAM 1036 as virtual memory. A specific primary storage device 1034 such as a CD-ROM may also pass data uni-directionally to the CPUs 1032.

CPUs 1032 are also coupled to one or more input/output devices 1040 that may include, but are not limited to, devices such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPUs 1032 optionally may be coupled to a computer or telecommunications network, e.g., an Internet network or an intranet network, using a network connection as shown generally at 1012. With such a network connection, it is contemplated that the CPUs 1032 might receive information from the network, or might output information to the network in the course of performing the above-described method steps. Such information, which is often represented as a sequence of instructions to be executed using CPUs 1032, may be received from and outputted to the network, for example, in the form of a computer data signal embodied in a carrier wave. The above-described devices and materials will be familiar to those of skill in the computer hardware and software arts.

As previously mentioned, a virtual machine may execute on computer system 1030. FIG. 7 is a diagrammatic representation of a virtual machine, which is supported by computer system 1030 of FIG. 6, and is suitable for implementing the present invention. When a computer program, e.g., a computer program written in the Java™ programming language, is executed, source code 1110 is provided to a compiler 1120 within compile-time environment 1105. Compiler 1120 translates source code 1110 into bytecodes 1130. In general, source code 1110 is translated into bytecodes 1130 at the time source code 1110 is created by a software developer.

Bytecodes 1130 may generally be reproduced, downloaded, or otherwise distributed through a network, e.g., network 1012 of FIG. 6, or stored on a storage device such as primary storage 1034 of FIG. 6. In the described embodiment, bytecodes 1130 are platform independent. That is, bytecodes 1130 may be executed on substantially any computer system that is running on a suitable virtual machine 1140.

Bytecodes 1130 are provided to a runtime environment 1135, which includes virtual machine 1140. Runtime environment 1135 may generally be executed using a processor or processors such as CPUs 1032 of FIG. 6. Virtual machine 1140 includes a compiler 1142, an interpreter 1144, and a runtime system 1146. Bytecodes 1130 may be provided either to compiler 1142 or interpreter 1144.

When bytecodes 1130 are provided to compiler 1142, methods contained in bytecodes 1130 are compiled into machine instructions. In one embodiment, compiler 1142 is a just-in-time compiler which delays the compilation of methods contained in bytecodes 1130 until the methods are about to be executed. When bytecodes 1130 are provided to interpreter 1144, bytecodes 1130 are read into interpreter 1144 one bytecode at a time. Interpreter 1144 then performs the operation defined by each bytecode as each bytecode is read into interpreter 1144. That is, interpreter 1144 “interprets” bytecodes 1130, as will be appreciated by those skilled in the art. In general, interpreter 1144 processes bytecodes 1130 and performs operations associated with bytecodes 1130 substantially continuously.

When a method is invoked by another method, or is invoked from runtime environment 1135, if the method is interpreted, runtime system 1146 may obtain the method from runtime environment 1135 in the form of a sequence of bytecodes 1130, which may be directly executed by interpreter 1144. If, on the other hand, the method which is invoked is a compiled method which has not been compiled, runtime system 1146 also obtains the method from runtime environment 1135 in the form of a sequence of bytecodes 1130, then may go on to activate compiler 1142. Compiler 1142 then generates machine instructions from bytecodes 1130, and the resulting machine-language instructions may be executed directly by CPUs 1032. In general, the machine-language instructions are discarded when virtual machine 1140 terminates. The operation of virtual machines or, more particularly, Java™ virtual machines, is described in more detail in The Java™ Virtual Machine Specification by Tim Lindholm and Frank Yellin (ISBN 0-201-63452-X), which is incorporated herein by reference.

While the invention has been particularly shown and described with reference to specific embodiments thereof, it will be understood by those skilled in the art that changes in the form and details of the disclosed embodiments may be made without departing from the spirit or scope of the invention. For example, the embodiments described above may be implemented using firmware, software, or hardware. Moreover, embodiments of the present invention may be employed with a variety of communication protocols and should not be restricted to the ones mentioned above. Therefore, the scope of the invention should be determined with reference to the appended claims.

In summary, the solution presented here is a non-API mechanism for bootstrapping a user database (i.e. accepting new user registrations from the web-tier) that is consistent with the goals of the J2EE platform, and can also be used in many other systems. This mechanism has many of the same advantages as the API-centric approaches used in the majority of systems today, such as the ability to customize look and feel of the registration form and the ability to prompt for user profile data at the same time security data is prompted for. Additionally, it avoids many of the disadvantages found in API-centric systems, such as the need for the web-application provider to worry about the details of implementing user registration, and the need to rewrite portions of application code when new authentication mechanisms are introduced.

What is claimed is:

1. In a browser/server environment, a method for bootstrapping a user database associated with an application from an application server, comprising:
forming a user information request page by the application;
sending the user information request page to a user;
returning a filled out user information request page to a pass through server target on the application server;
extracting security data from the filled out user information page by the application server; and
bootstrapping a user account in the user database by the application server based upon the extracted security data.

2. A method as recited in claim 1, further comprising:
forwarding the filled out user information request page to the application by the application server.

3. A method as recited in claim 1, wherein the application server makes available a set of user security requirements to the application that define security data required to bootstrap the user account in the user database.

4. A method as recited in claim 1, wherein the application includes a success target and a failure target, wherein the success target provides a success destination when the bootstrapping is successful, and wherein the failure target provides a failure destination when the bootstrapping is unsuccessful.

5. A method as recited in claim 4, wherein the success destination is a success URL and wherein the failure destination is a failure URL.

6. A method as recited in claim 1 wherein the forming a user information request page comprises:
merging the set of security registration requirements and user profile data requirements by the application; and
collecting corresponding user profile data from the user.

7. A method as recited in claim 6, wherein the forwarding the filled out user information page to the application comprises:
forwarding a subset of the security data and the collected user profile data.

8. A method as recited in claim 7, further comprising:
extracting the collected user profile data from the forwarded filled out user information page.

9. A method as recited in claim 8, wherein the collected user profile data is stored in a user profile database.

10. In a browser/server environment, an apparatus for bootstrapping a user database associated with an application from an application server, comprising:
a means for forming a user information request page by the application;
a means for sending the user information request page to a user;
a means for returning a filled out user information request page to the application server;
a means for extracting security data from the filled out user information page by the application server; and
a means for bootstrapping a user account in the user database by the application server based upon the extracted security data.

11. An apparatus as recited in claim 10, further comprising:
a means for forwarding the filled out user information request page to the application.

12. An apparatus as recited in claim 10, wherein the application server makes available a set of user security requirements to the application that define security data required to bootstrap the user account in the user database.

13. An apparatus as recited in claim 10, wherein the application includes a success target and a failure target, wherein the success target provides a success destination when the bootstrapping is successful, and wherein the failure target provides a failure destination when the bootstrapping is unsuccessful.

14. An apparatus as recited in claim 13, wherein the success destination is a success URL and wherein the failure destination is a failure URL.

15. An apparatus as recited in claim 10 wherein the forming a user information request page comprises:
merging the set of security registration requirements and user profile data requirements by the application; and
collecting corresponding user profile data from the user.

16. An apparatus as recited in claim 15, wherein the forwarding the filled out user information page to the application comprises:
forwarding a subset of the security data and the collected user profile data.

17. An apparatus as recited in claim 16, further comprising:
extracting the collected user profile data from the forwarded filled out user information page.

18. An apparatus as recited in claim 17, wherein the collected user profile data is stored in a user profile database.

19. A computer program product for enabling a computing system to bootstrap a user database associated with an application from an application server, the computer program product in a browser/server environment, comprising:
computer code for forming a user information request page by the application;
computer code for sending the user information request page to a user;
computer code for returning a filled out user information request page to the application server;
computer code for extracting security data from the filled out user information page by the application server;
computer code for bootstrapping a user account in the user database by the application server based upon the extracted security data; and
a computer readable medium for storing the computer program product.
